(19) United States
(12) Patent Application Publication
(10) Pub. No.: US 2018/0338423 A1
(43) Pub. Date: Nov. 29, 2018

(54) STRUCTURAL SET FOR ASSEMBLY OF A HEADER AND HARVESTING MACHINE

(71) Applicant: CNH Industrial America LLC, New Holland, PA (US)

(72) Inventors: Joao Lucca, Sao Pedro (BR); Andre Seki, Sorocaba (BR); Carlos Visconti, Sao Paulo (BR)

(21) Appl. No.: 15/988,242

(22) Filed: May 24, 2018

(30) Foreign Application Priority Data
May 24, 2017 (BR) 1020170108597

(51) Int. Cl. A01D 45/10; A01D 41/14; A01D 41/127

(52) U.S. Cl. CPC A01D 45/10; A01D 45/003; A01D 41/127; A01D 41/141

(57) ABSTRACT

The present invention relates to a structural set for the assembly of a header intended for harvesters, comprising technical, constructive and functional aspects capable of promoting the tilting adjustment of the header in order to improve the accuracy levels of the angle of attack of the cutting discs during harvesting. More particularly, the present invention refers to a structural set for the assembly of a header in agricultural machines comprising a girder formed by a central beam on which a support is provided for suitable fitting of the structure of the header, the central beam being anchored to the chassis of the agricultural machine by an actuator device and further connecting at least two support columns, which are pivoted on the chassis of the agricultural machine by fastening device(s).

### CROSS REFERENCE TO RELATED APPLICATION

This application claims priority to Brazilian Application No. 1020170108597 filed May 24, 2017, the contents of which are incorporated herein by reference.

### FIELD OF THE INVENTION

The present invention refers to a structural set for assembly of headers for agricultural machines, such as sugarcane harvesters.

The present invention further refers to a harvesting machine comprising the structural set for header assembly.

### BACKGROUND OF THE INVENTION

Several models of agricultural machines and equipment are known to promote increased productivity in the harvesting of various types of plant crops, such as machines for harvesting grains in general, forage machines and machines for harvesting tall stem plants, such as sugarcane harvesters.

It is known that grain harvesting machines, also known as grain harvesters or combine harvesters, have a configuration that allows harvesting different types of grains, and a header is attached to the front portion of the machine whose characteristics depend on the type of crop to be harvested, such as wheat, soybeans, corn, rice, etc.

In turn, forage machines are agricultural machines designed to harvest and grind a given plant crop to obtain forage, for example hay.

Particularly in relation to tall stem plants, such as sugarcane, energy cane and sweet sorghum, harvesting machines are designed and developed to promote the harvesting of this specific type of crop, this is why their intrinsic characteristics require specific conditions for their safe and proper processing, from cutting to transfer to overboard baskets and carts.

Therefore, the sugarcane and/or sweet sorghum harvesting machine generally has a fixed opening for receiving and harvesting the planting rows, which are generally spaced at relatively fixed and predetermined distances of 0.9 m or of 1.5 m, or also machines designed to collect two simultaneous rows within these spacings. Optionally, the harvesting machine of this type of plant crop can also have a variable aperture, which can optionally harvest one or two planting rows spaced 0.9 m or 1.5 m apart, or planting rows with spacing alternating between 0.9 and 1.5 m. A proposed solution for a sugarcane harvester having the possibility of adjusting the opening to harvest crops having different spacings between the planting rows is disclosed, for example, in WO2014/026255, which is incorporated herein as a reference.

The cultivation of sugarcane and sweet sorghum goes through a great evolution, both in terms of the development of new varieties of plants, and in terms of different planting configurations, always with the aim of increasing productivity, both in relation to quantity of tons harvested per hectare and in relation to the quantity of alcohol and/or sugar produced per ton harvested. Furthermore, applications of these plant crops are also known for the generation of energy from their biomass, where, unlike the production of alcohol and sugar, not only the part of the plant stem is used, but also the foliage and, possibly, the inflorescence. Hence, sugarcane varieties destined to the generation of energy, commonly denominated energy cane, are also being developed to increase the amount of fibers and reduce the amount of concentrated sucrose in the plant.

One of the main problems observed in sugarcane and sweet sorghum plantations is that harvesting machines are restricted to in-row harvesting, that is, they are sensitive to planting rows and can only harvest the crop if it is planted in established planting rows, such as planting rows spaced 0.9 m or 1.5 m, or rows alternately spaced by 0.9 m and 1.5 m. In the case of plantations intended to obtain biomass, planting in rows is not necessary, that is, the planting can be done in a random way and, for this reason, conventional sugarcane and sorghum harvesting machines cannot promote the collection of this material.

One option, in the case of harvesting for biomass generation, would be the replacement of sugarcane and sweet sorghum harvesters by forage machines. However, forage machine do not prove efficient either for harvesting tall stem plants, such as sugarcane and sweet sorghum, since the header intended for forage harvesting, such as those provided by Kemper, from Münster, Germany, do not provide a good performance for harvesting this type of plants, because they exhibit great wear, they leave a great amount of biomass on the ground and they are not efficient in feeding the plants to the machine.

Another drawback observed in sugarcane and/or sweet sorghum harvesting machines is the fact that the front elements, such as row dividers, knock-down rollers, base cutting discs and lift rollers, are fastened to the chassis itself of the harvesting machine. As will be appreciated by those skilled in the art, these front elements are those that are most prone to wear, because they are precisely those that are in front line in contact with the soil and the plant culture, besides absorbing impacts. Thus, if any of these front elements are damaged during harvesting and need to be repaired or replaced, the harvesting machine needs to be picked up for proper maintenance and, as a result, the harvesting will be interrupted until the machine is either returned from maintenance or replaced by another machine.

In order to attempt to overcome some of the drawbacks above, documents US 2014/0174048, by CNH America LLC, which is also to be incorporated herein as a reference, discloses a biomass harvesting system consisting of a sugarcane harvester whose basic front elements have been removed to allow the installation of an independent header in front of a conveyor roller set. The header being, for instance, a forage header for harvesting a plant crop, such as sugarcane and/or sweet sorghum, which was planted without a specific planting row pattern. In this sense, the machine disclosed in this document allows a greater variability for harvesting a planted plant crop with no regular planting rows or, in other words, allows harvesting independent of planting rows or lines.

Document BR 10 2015 015922 6, by CNH Industrial Latin America Ltda., discloses a sugarcane harvesting header and the like which can be coupled to the front portion of a harvesting machine, such as the above-mentioned harvester described in document US 2014/0174048, and thereby providing greater flexibility to harvest crops planted with different spacings, being able to change only the header, and not necessarily the whole machine. Moreover, if any of the front elements of the header is damaged during use, it is not necessary to stop the machine, but only change the header.

Furthermore, this flexibility in adapting the harvesting machine eliminates the need to stop the whole machine in case of damage to the front elements that are in the independent structure of the header and, therefore, it is enough for the farmer to replace this header while carrying out the necessary maintenance. As a result, it is not necessary to paralyze the harvest for long periods until the repair, for example, of only one front element of the machine.

In spite of being highly functional and solving a number of problems known in the prior art and discussed above, in practice it has been observed that such agricultural equipment and machines could be improved and enhanced, particularly with regard to proper positioning of the header in relation to the ground to obtain the cutting of the plants in a more appropriate condition, that is, a cut with more quality, with less damages to the plants and a less loss of material harvested and, therefore, to ensure a more efficient harvest.

Although most of the known harvester machines in the state of the art comprise suspension systems capable of raising and lowering the front of the machines and thereby raising and lowering the headers relative to the ground, in some situations the slope generated by the lifting and lowering of the front of the harvester is not sufficient to position the blades of the base cutting discs properly to obtain the precise and quality cutting of the plant stems.

This type of restriction is even more noticeable when using headers that are attachable to the chassis of the harvester, since some models end up having a relatively long length and, therefore, the effects of lifting the front portion of the machine end up being greatly reduced in relation to the positioning of the base cutting discs.

In order to try to provide some solution for the correction of the positioning of the base cutting discs, according to the state of the art, some systems of lifting the base cutting discs were developed to obtain an adjustment of the distance of the blades from the ground and, with this, try to improve the quality of the cut of the plants. For example, document WO 2015/003058, by CNH Industrial America LLC, which is to be incorporated herein by reference, describes a technical solution for obtaining the individual height adjustment of the base cutting discs of a cane harvester and is comprised of a combination of pressure and position sensors which determine the height adjustment of the base cutting discs independently so that the height of each base cutting disc is adjusted according to the planting row being cut in the case of headers for harvesting multiple planting rows.

However, even though these solutions proposals were efficient, it was also verified the need to produce a simpler technology that generated less weight, considering that the weight of the header is a sensitive variable.

### SUMMARY OF THE INVENTION

Hence, based on the above, the present invention provides a structural set for assembling a header intended for harvesters, which consists of technical, constructive and functional features capable of providing the inclination of the header and, thus, to obtain a more accurate positioning of the base cutting discs relative to the plant stems being cut along the planting row being harvested.

The present invention provides a structural set for assembling a header having a tilt adjustment system capable of positioning the header automatically according to the ground and working conditions of the base cutting discs.

Furthermore, the present invention provides a harvesting machine preferably intended for sugarcane and/or sorghum harvest, comprising the present structural set for header assembly.

The present invention is comprised of a structural set for assembling a header in an agricultural machine, of the high stem-harvesting type, the structural set being formed by a girder which basically consists of a central beam on which a support for engaging and securing the header structure is arranged, the central beam being anchored close to the chassis of the machine by means of a driving device. In addition, the central beam is connected to at least two support columns, which are suitably pivoted next to the chassis of the agricultural machine by a fastening device(s).

According to one of the embodiment of the present invention, the fastening device(s) can be pivoting shafts provided on the base of the support columns, which are engaged in respective holes arranged in the lower part of the material input of the chassis of the agricultural machine.

Particularly with respect to the actuator device, according to some possible embodiments of the present invention, it may be a hydraulic, electrical, mechanical mechanism or even a combination thereof. More particularly, such actuating device may be a hydraulic piston driven by the hydraulic system of the agricultural machine itself. Alternatively, such actuator device may be a thread driven by an electric or hydraulic motor.

Yet according to another embodiment of the present invention, the actuator device is controlled by a processing unit that is fed with sensor signals installed in the header structure. These sensors may be of the type capable of measuring the height between the header structure and the ground. These sensors are optionally of the pressure type, which are coupled in respective row dividers of the cutting header. In yet another possible embodiment of the present invention, such pressure sensors are installed in the base cutting discs to detect any changes in the cutting time of the plants.

The present invention further relates to a harvesting machine of the type intended for harvesting tall stem plants, comprising a chassis mounted on conveyor belts or wheels, a drive motor, a cabin for operation and control, primary cleaning extractor systems and a billet elevator, the machine being designed to comprise the structural set for the assembly of the cutting header, as defined by the present invention.

According to an embodiment of the present invention, the harvesting machine is intended for cutting and harvesting sugarcane and/or sweet sorghum.

### BRIEF DESCRIPTION OF THE DRAWINGS

The characteristics, advantages and technical effects of the present invention, as set forth above, will be better and more suitably understood by one skilled in the art from the following detailed description, taken by way of example, and not limiting, of preferred embodiments, and with reference to the accompanying schematic drawings, wherein:

FIG. 1 shows a side view of a sugarcane harvesting machine;

FIG. 2 shows a front view of the header assembled in the structural set, according to the present invention;

FIG. 3 shows a perspective view of the structural set, according to the present invention, coupled to the chassis of the harvesting machine;

FIG. 4 shows a side view of the structural set, uncoupled from the cutting head and the chassis of the harvesting machine;

FIG. 5A shows a side view of the structural set, fastened to the chassis of the harvesting machine and holding the cutting header in the horizontal position;

FIG. 5B shows a side view of the structural set, fastened to the chassis of the harvesting machine and holding the cutting header in the tilted position;

FIG. 6 shows a partially sectional bottom perspective view of the structural set, according to the present invention, duly assembled on the chassis of the harvesting machine and holding the header; and

FIG. 7 shows a schematic block diagram of the control mechanism of the actuator devices of the structural set.

### DETAILED DESCRIPTION OF THE INVENTION

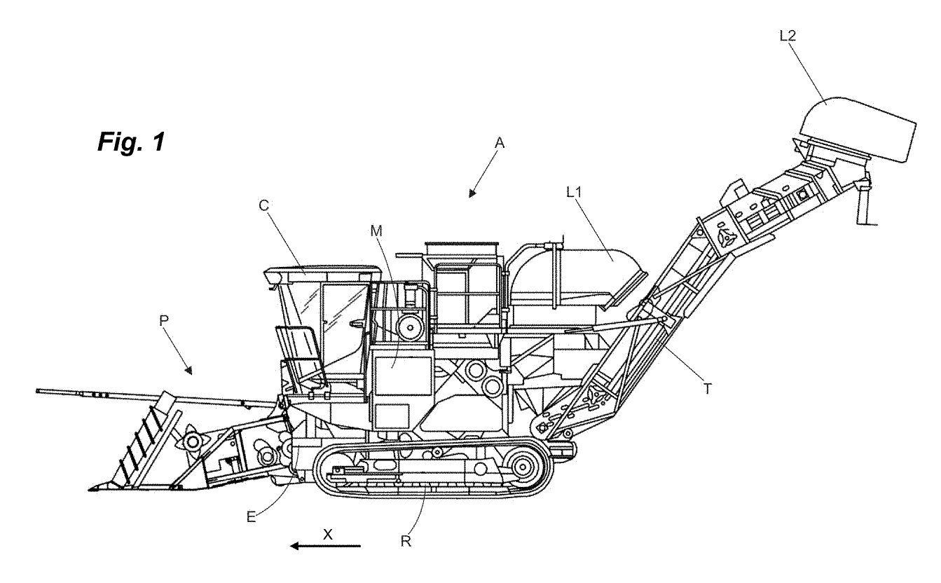

The particular embodiments of the invention are described herein with reference to the appended figures. These figures are schematic and their sizes and/or proportions may not correspond to reality, given that they aim at describing the invention in a didactic manner. Moreover, certain known and common constructive details may have been omitted for greater clarity and conciseness of the description which follows. The used reference numerals are repeated throughout the figures to identify identical or similar parts. Possibly used terms as: “above”, “below”, “front”, “rear”, “left”, etc. and their variations must be construed according to the guidance provided in FIG. 1.

FIG. 1 shows a schematic representation of an agricultural machine (A) of the sugarcane harvester type. Although the present specification relates to a sugar cane harvester, it is clear that the machine may also be employed for the harvesting of other tall stem plants such as sorghum. A harvesting machine (A) may be, for instance, a machine known in the state of the art, made available by CNH Industrial N.V. marketed under the trademark Case IH.

The harvesting machine (A) comprises a chassis (E) mounted on conveyor belts (R) or wheels, a drive motor (M), an operation and control cabin (C), a primary cleaning extractor system (L1), a billet elevator (T) with secondary cleaning extractor system (L2) transferring the billets to, for instance, an overboard or prilling bucket (not shown). Furthermore, the harvesting machine (A) is designed to receive a front cutting header (P) through the assembly structural set, object of the present invention.

The machine (A) moves along the ground (S) in a harvesting direction, represented by the arrow (X) in FIG. 1, towards one or more rows of plants planted at regular spacings (not shown).

A harvester and header as above are described in greater detail, for instance, in US 2014/0174048 and BR 10 2015 0159226, respectively, both incorporated as a reference for the present invention.

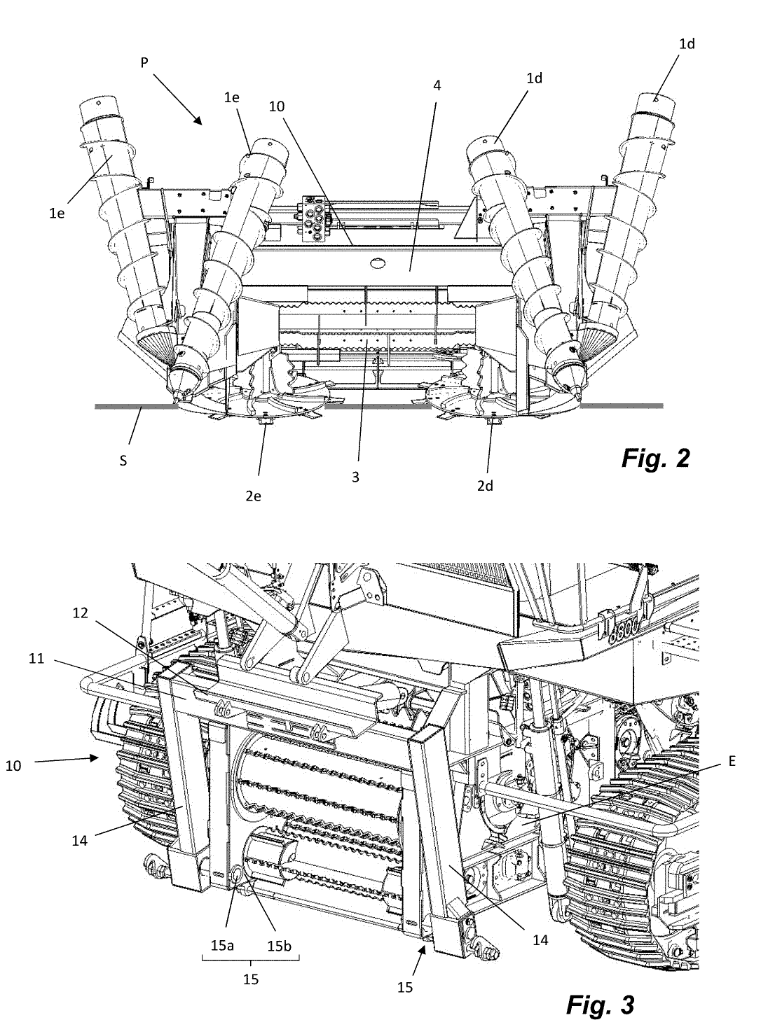

Particularly with reference to FIG. 2, the header (P) comprises a structure 4, into which the basic cutting elements such as row dividers 1d, 1e, base cutting discs 2d, 2e, knock-down roller 3 are inserted and/or incorporated, the header being mounted, fitted and fastened to the chassis of the harvesting machines through the structural set 10.

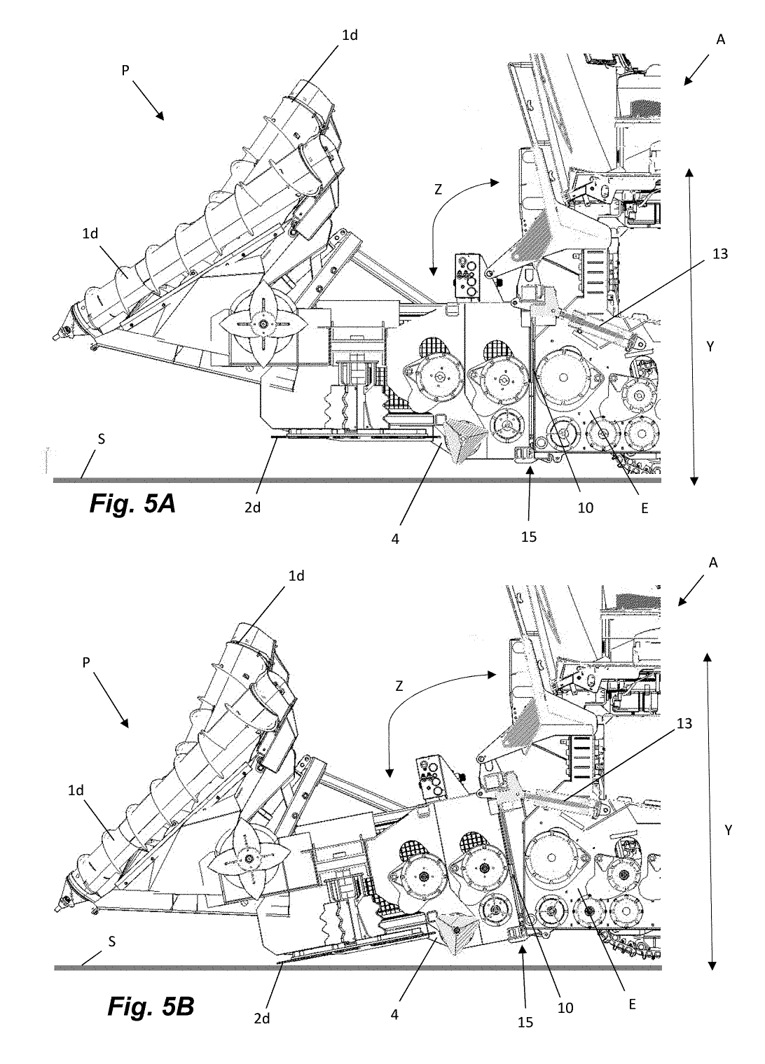

By way of example only, and as mentioned above, some models of sugarcane or sweet sorghum harvesting machines comprise suspension mechanisms capable of promoting the height adjustment of the front of the machines, as indicated by the representative arrow “Y” in FIGS. 5A and 5B. Furthermore, as previously discussed with reference to WO2015/003058, there are some equipment featuring a technology capable of vertically moving the sets of base cutting discs to position them independently and according to the planting row being cut, particularly applied in the case of multi-row harvesters, and thus to achieve height control between the base cutting discs 2d, 2e and the ground (S).

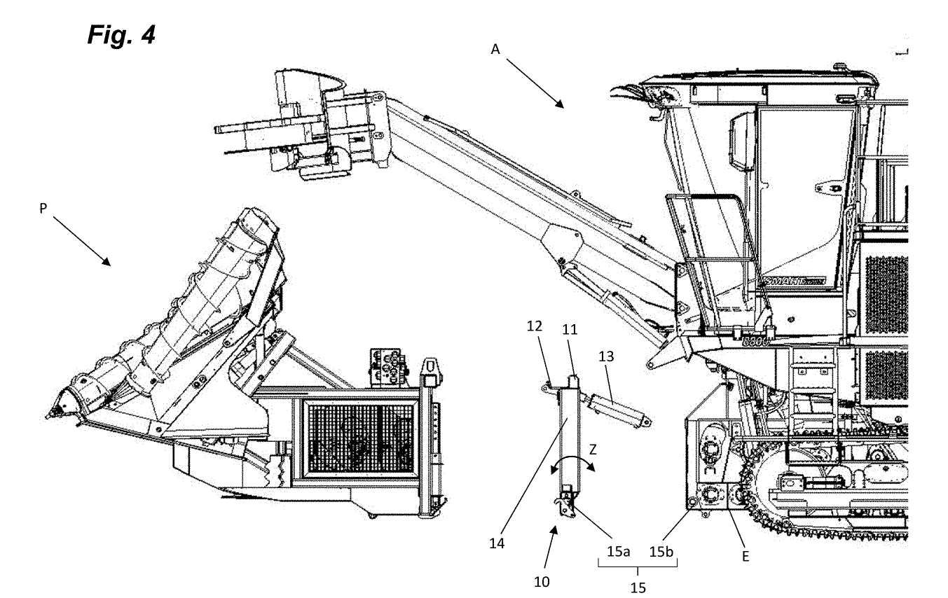

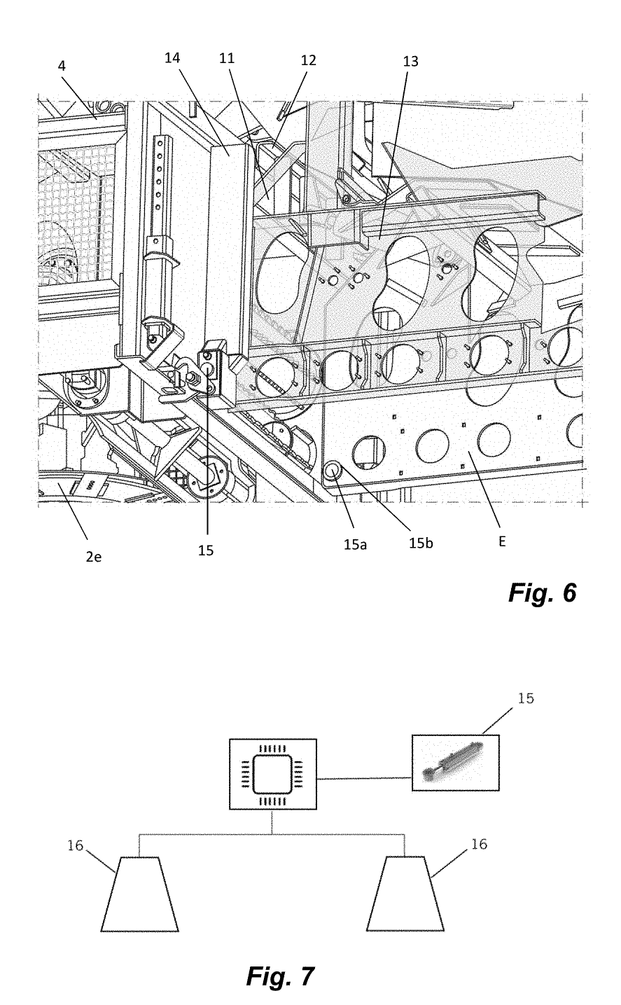

With reference to FIGS. 3 to 6, the assembly structural set 10, consists of a beam formed by a central beam 11 on which a support 12 is arranged for the engagement and fastening of the structure 4 of the header (P), the central beam (11) being anchored to the chassis (E) of the agricultural machine (A) by way of an actuator device 13 and further connecting at least two support columns 14, which are pivoted on the chassis (E) of the agricultural machine (A) by fastening device(s) 15.

The fastening device(s) 15 preferably include pivoting shafts 15a provided on the base of the support columns 14 fitting into holes 15b provided in the bottom of the chassis input (E).

According to the present invention, the actuator device 13 can be a hydraulic, electrical, mechanical device or even a combination of these technologies. By way of example of one embodiment, the actuating device 13 may be a hydraulic piston which is driven by the hydraulic system itself of the agricultural machines (A). The actuator device may be a thread driven by an electric or hydraulic motor.

As shown in the appended Figures, especially in FIGS. 3, 5A and 5B, the actuator device 13 promotes the withdrawal of the central beam 11 and, due to the fastening promoted by the fastening device(s) 15, the girder supporting the structure 4 of the header (P) performs the tilting movement, as indicated by the representative arrow “Z”. In this way, the angle of attack of the blades of the base cutting discs 2d, 2e can be precisely adjusted.

In addition, according to one embodiment of the present invention, the actuator device 13 is controlled by a processing unit (CPU) receiving signals from sensors 16 provided on the header (P) responsible for measuring the height of the structure 4 of the header (P) in relation to the ground (S). The sensors 16 may optionally also be coupled at the ends of the row dividers 1d, 1e, such as in the skid of the row dividers, to measure the pressure exerted by the header relative to the ground (S). Furthermore, a further alternative form of the sensors 16 is their arrangement on the base cutting discs 2d, 2e, particularly in their motors, in order to obtain the measurement of the pressure exerted by the blades during plant stems cutting.

Obviously, nothing prevents all of these sensor models 16 from working simultaneously, causing the processing unit (CPU) to receive and process a series of signals and thereby be able to position more precisely the angle of attack of the blades of the base cutting discs 2d, 2e.

As will be appreciated by those skilled in the art, with the assembly structural set 10, according to the present invention, it becomes possible to improve the positioning accuracy of the base cutting discs 2d, 2e in relation to the plant stems. More particularly, it is noted that the present assembly structural set 10 is able to adjust the angle of attack of the blades of the base cutting discs 2d, 2e, so as to obtain a quality cut mainly considering the tilted position that the plants are arranged by virtue of the action of the knock-down rollers 3 of the headers (P), thereby providing a cut executed substantially perpendicular to the plant stems.

In addition, as mentioned above, the present invention also relates to a harvesting machine, for example the machine (A) for harvesting tall stem plants, which is designed to comprise a structural set 10, according to the present invention, intended for the assembly and fastening of a header (P), which comprises a structure 4 where the basic front cutting elements are arranged, such as the row dividers 1d, 1e, sets of base cutting discs 2d, 2e and the knock-down roller 3.

According to an embodiment of the present invention, the harvesting machine (A) is intended for sugarcane and/or sweet sorghum harvesting.

Thus, considering all of the above, it is noteworthy that the structural set 10 for assembling the headers (P) of the harvesting machines (A), as defined by the present invention, allows to obtain agricultural equipment of high productivity, since it manages to obtain a better cutting of the plant stems, mainly in order to more accurately adjust the angle of attack of the blades of the base cutting discs 2d, 2e, thereby eliminating the risks of material loss due to improper cutting of plant stems.

Finally, considering the above, it should be pointed out that the purpose of the present description is only to disclose and define in an exemplary way possible embodiments of the structural set for assembling headers of agricultural machines capable of promoting the precise adjustment of the angle of attack of the base cutting discs. Thus, as will be clear to those skilled in the art, numerous modifications and adaptations of elements and equivalent technical/construction details are possible without thereby departing from the scope of protection delimited by the appended claims.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A STRUCTURAL SET FOR ASSEMBLY OF A HEADER comprising a girder formed by a central beam on which a support is arranged for the engagement and fastening of said structure of the header, said central beam being anchored to the chassis of the agricultural machine by an actuator device and further connecting at least two support columns, the at least two supporting columns being pivoted on the chassis of said agricultural machine by at least one fastening device.

2. The STRUCTURAL SET, according to claim 1, wherein the at least one said fastening device includes a plurality of pivoting shafts arranged on the base of said support columns, which fit into holes provided in the bottom of the chassis input.

3. The STRUCTURAL SET, according to claim 1, wherein said actuator device is a hydraulic, electrical, mechanical mechanism or a combination thereof.

4. The STRUCTURAL SET, according to claim 1, wherein said actuator device is a hydraulic piston driven by the hydraulic system of the agricultural machines.

5. The STRUCTURAL SET, according to claim 1, wherein said actuator device is a thread driven by an electric or hydraulic motor.

6. The STRUCTURAL SET, according to claim 1, wherein said actuator device is controlled by a processing unit (CPU) which receives sensor signals from sensors arranged on the header.

7. The STRUCTURAL SET, according to claim 6, wherein said sensors are sensors measuring the height between the structure of the header and the ground.

8. The STRUCTURAL SET, according to claim 6, wherein said sensors are pressure sensors coupled to row dividers of said header.

9. The STRUCTURAL SET, according to claim 6, wherein said sensors are pressure sensors installed on base cutting discs of said header (P).

10. A HARVESTING MACHINE for tall stem plant harvesting, comprising; a chassis assembled on conveyor belts or wheels, a drive motor, a cabin for operation and control, primary and secondary cleaning extractor systems, a billet elevator, and a structural set for the assembly of the cutting header, the structural set comprising:
a girder formed by a central beam on which a support is arranged for the engagement and fastening of said structure of the header, said central beam being anchored to the chassis of the agricultural machine by an actuator device and further connecting at least two support columns, the at least two supporting columns being pivoted on the chassis of said agricultural machine by at least one fastening device (15).

11. The HARVESTING MACHINE, according to claim 10, wherein the harvesting machine is intended for sugarcane and/or sweet sorghum harvesting.
